(19) United States
(12) Patent Application Publication
(10) Pub. No.: US 2014/0223466 A1
(43) Pub. Date: Aug. 7, 2014

(54) Method and Apparatus for Recommending Video from Video Library

(71) Applicant: Huawei Technologies Co., Ltd., Shenzhen (CN)

(72) Inventors: Jing Wang, Shenzhen (CN); Yasong Huang, Shenzhen (CN); Jun Xu, Hong Kong (CN)

(73) Assignee: Huawei Technologies Co., Ltd., Shenzhen (CN)

(21) Appl. No.: 14/103,408

(22) Filed: Dec. 11, 2013

Related U.S. Application Data
(63) Continuation of application No. PCT/CN2013/080687, filed on Aug. 2, 2013.

(30) Foreign Application Priority Data
Feb. 1, 2013 (CN) 201310041000.1

(51) Int. Cl. H04N 21/25

(52) U.S. Cl. CPC H04N 21/251
USPC 725/14

(57) ABSTRACT

A method for recommending a video from a video library, and the method includes obtaining a user session composed of unrestricted content; analyzing semantics of the user session; according to the semantics of the user session, selecting subtitles that match the semantics of the user session from subtitles included in the video library, where the subtitles are used to answer the user session; from the video library, obtaining a video clip corresponding to the subtitles used to answer the user session; and presenting the video clip or sending the video clip so that a receiver can present the video clip. The embodiments of the present invention fulfill the objective of recommending a video to a user in a smart and personalized manner.

### CROSS-REFERENCE TO RELATED APPLICATIONS

This application is a continuation of international application no. PCT/CN2013/080687, filed on Aug. 2, 2013, which claims priority to Chinese patent application no. 201310041000.1, filed on Feb. 1, 2013, all of which are hereby incorporated by reference in their entireties.

### TECHNICAL FIELD

The present invention relates to the computer field and provides a method and an apparatus for recommending a video from a video library.

### BACKGROUND

When a user selects a video for watching from a video library, the user is usually unsure what to watch, and depends on recommendation on the website. Currently, recommendation modes mainly include homepage recommendation, rank by score, and classified search. The classified search technology is the most frequently used video recommendation mode.

However, a video recommendation method using classified search cannot take account of user information, and scarcely varies with users, and all users have to use the same classification method to filter videos. Moreover, sorting in classified recommendation seldom changes, which makes the users feel dull after repeated login.

### SUMMARY

Embodiments of the present invention provide a method and an apparatus for recommending a video from a video library, to recommend the video to a user in a smart and personalized manner.

According to a first aspect, an embodiment of the present invention provides a method for recommending a video from a video library, and the method includes: obtaining a user session composed of unrestricted content; analyzing semantics of the user session; according to the semantics of the user session, selecting subtitles that match the semantics of the user session from subtitles included in the video library, where the subtitles are used to answer the user session; from the video library, obtaining a video clip corresponding to the subtitles used to answer the user session; and presenting the video clip or sending the video clip so that a receiver can present the video clip.

In a first implementation manner of the first aspect, the selecting, according to the semantics of the user session, subtitles that matches the semantics of the user session from subtitles included in the video library, includes: according to the semantics of the user session and context information of the user session, selecting the subtitles that match the semantics of the user session from the subtitles included in the video library; the context information of the user session includes input time information of the user session, input position information of the user session, weather information in the input position at the input time, or user behavior information of the user session.

With reference to the first aspect, or the first implementation manner of the first aspect, in a second implementation manner of the first aspect, the selecting, according to the semantics of the user session, subtitles that match the semantics of the user session from subtitles included in the video library, includes: using the semantics of the user session as an input, and calculating correlation separately for the subtitles included in the video library; ranking the subtitles included in the video library according to a result of the correlation calculation; and selecting subtitles ranked first or high as the subtitles that matches the semantics of the user session.

With reference to the first aspect, or any one of the foregoing implementation manners of the first aspect, in a third implementation manner of the first aspect, before the step of obtaining the user session composed of unrestricted content, the method further includes: initiating a proactive session, where the proactive session is obtained according to context information of the proactive session; the context information of the proactive session includes initiation time information of the proactive session, object position information of the proactive session, weather information in the object position at the initiation time, and user habit history information of a proactive session object.

With reference to the first aspect, or any one of the foregoing implementation manners of the first aspect, in a fourth implementation manner of the first aspect, the obtaining from the video library a video clip corresponding to the subtitles used to answer the user session and presenting the video clip, or sending the video clip so that a receiver can present the video clip, includes: from the video library, obtaining multiple video clips corresponding separately to multiple subtitles used to answer the user session and presenting the multiple video clips, or sending the multiple video clips so that the receiver can present the multiple video clips; and, after the step of obtaining from the video library multiple video clips corresponding to subtitles used to answer the user session and presenting the multiple video clips, or sending the multiple video clips so that the receiver can present the multiple video clips, the method further includes: obtaining a video clip selection instruction of selecting a specified video clip from the presented multiple video clips; and setting a video, which includes the selected specified video clip, as a video to be played.

With reference to the first aspect, or any one of the foregoing implementation manners of the first aspect, in a fifth implementation manner of the first aspect, the user session includes a voice session or includes a hybrid session that includes a voice session and a text session; and the obtaining the user session composed of unrestricted content includes receiving the voice session composed of unrestricted content or the hybrid session that includes a voice session and a text session.

With reference to the first aspect, or any one of the foregoing implementation manners of the first aspect, in a sixth implementation manner of the first aspect, the user session includes a text session; and the obtaining the user session composed of unrestricted content includes obtaining a text session composed of unrestricted content.

With reference to the first aspect, or any one of the foregoing implementation manners of the first aspect, in a seventh implementation manner of the first aspect, the user session includes a multilingual hybrid session; and the obtaining the user session composed of unrestricted content includes obtaining a multilingual hybrid session composed of unrestricted content.

According to a second aspect, an embodiment of the present invention provides an apparatus for recommending a video from a video library, and the apparatus includes: a session obtaining module, a semantics analyzing module, subtitles selecting module, a video clip obtaining module, and a video clip presenting module, where: the session obtaining module is configured to obtain a user session composed of unrestricted content; the semantics analyzing module is configured to analyze semantics of the user session; the subtitles selecting module is configured to: according to the semantics of the user session, select subtitles that match the semantics of the user session from subtitles included in the video library, where the subtitles are used to answer the user session; the video clip obtaining module is configured to obtain from the video library a video clip corresponding to the subtitles used to answer the user session; and the video clip presenting module is configured to present the video clip, or send the video clip so that a receiver can present the video clip.

In a first implementation manner of the second aspect, the subtitles selecting module is specifically configured to: according to the semantics of the user session and context information of the user session, select the subtitles used to answer the user session from the subtitles included in the video library; the context information of the user session includes input time information of the user session, input position information of the user session, weather information in the input position at the input time, or user behavior information of the user session.

With reference to the second aspect, or the first implementation manner of the second aspect, in a second implementation manner of the second aspect, the selecting, by the subtitles selecting module according to the semantics of the user session, subtitles that match the semantics of the user session from subtitles included in the video library, includes: using the semantics of the user session as an input, and calculating correlation separately for the subtitles included in the video library; ranking the subtitles in the video library according to a result of the correlation calculation; and selecting subtitles ranked first or high as the subtitles that matches the semantics of the user session.

With reference to the second aspect, or any one of the foregoing implementation manners of the second aspect, in a third implementation manner of the second aspect, the apparatus further includes a session initiating module, and the session initiating module is configured to initiate a proactive session before the user session composed of unrestricted content is obtained, where the proactive session is obtained according to context information of the proactive session; and the context information of the proactive session includes initiation time information of the proactive session, object position information of the proactive session, weather information in the object position at the initiation time, and user habit history information of a proactive session object.

With reference to the second aspect, or any one of the foregoing implementation manners of the second aspect, in a fourth implementation manner of the second aspect, the apparatus further includes a playing module, where the video clip obtaining module is specifically configured to obtain from the video library multiple video clips corresponding separately to multiple subtitles used to answer the user session; the video clip presenting module is specifically configured to present the multiple video clips, or specifically configured to send the multiple video clips so that a receiver can present the multiple video clips; the session obtaining module is further configured to obtain a video clip selection instruction of selecting a specified video clip from the presented multiple video clips; and the playing module is configured to set a video, which includes the selected specified video clip, as a video to be played.

With reference to the second aspect, or any one of the foregoing implementation manners of the second aspect, in a fifth implementation manner of the second aspect, the session obtaining module is specifically configured to obtain a voice session composed of unrestricted content, or a hybrid voice session that is composed of unrestricted content and includes a voice session and a text session.

With reference to the second aspect, or any one of the foregoing implementation manners of the second aspect, in a sixth implementation manner of the second aspect, the session obtaining module is specifically configured to obtain a text session composed of unrestricted content.

With reference to the second aspect, or any one of the foregoing implementation manners of the second aspect, in a seventh implementation manner of the second aspect, the session obtaining module is specifically configured to obtain a multilingual hybrid session composed of unrestricted content.

According to a third aspect, an embodiment of the present invention provides a system for recommending a video from a video library, where the system includes a cloud server and a terminal device. The terminal device is configured to receive a user session that is input by a user and composed of unrestricted content and send the user session to the cloud server; the cloud server is configured to: receive the user session composed of unrestricted content; analyze semantics of the user session; according to the semantics of the user session, select subtitles that match the semantics of the user session from subtitles included in the video library, where the subtitles are used to answer the user session; from the video library, obtain a video clip corresponding to the subtitles used to answer the user session; and send the video clip to the terminal device; and the terminal device is further configured to present the video clip.

In a first implementation manner of the third aspect, the cloud server is further configured to: initiate a proactive session, and send the proactive session to the terminal device, where the proactive session is obtained according to context information of the proactive session; the context information of the proactive session includes: initiation time information of the proactive session, object position information of the proactive session, weather information in the object position at the initiation time, and user habit history information of a proactive session object; and the terminal device is further configured to: before receiving the user session that is input by the user and composed of unrestricted content, receive the proactive session, and present the proactive session to the user, where the received user session composed of unrestricted content is triggered by the proactive session.

With reference to the third aspect, or the first implementation manner of the third aspect, in a second implementation manner of the third aspect, the cloud server is further configured to obtain from the video library multiple video clips corresponding separately to multiple subtitles used to answer the user session, obtain a video clip selection instruction of selecting a specified video clip from the multiple video clips, set a video, which includes the selected specified video clip, as a video to be played, and send to the terminal device the video to be played; and the terminal device is further configured to receive the video to be played and play the video to be played.

In the embodiments of the present invention, the semantics of the user session are analyzed, the subtitles that matches the semantics of the user session is selected from the subtitles included in the video library, and the video clip corresponding to the subtitles is played. In this way, video recommendation is combined with the user session, and both the literal meaning of the user session and the actual meaning of the user session are taken into full account, so that the video is recommended to the user in a smart and personalized manner. In addition, the use session interaction manner provides a flexible means of interaction that is more adaptive to the actual operation habits of the user, which improves practicality and efficiency of video recommendation.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and persons of ordinary skill in the art may still derive other drawings from these accompanying drawings without creative efforts.

FIG. 1 is a method flowchart of recommending a video from a video library according to an embodiment of the present invention;

FIG. 2 is a method flowchart of recommending a video from a video library according to another embodiment of the present invention;

FIG. 3 is a schematic structural diagram of an apparatus for recommending a video from a video library according to an embodiment of the present invention;

FIG. 4 is a schematic structural diagram of an apparatus for recommending a video from a video library according to another embodiment of the present invention;

FIG. 5 is a schematic structural diagram of a computer system for recommending a video from a video library according to an embodiment of the present invention; and

FIG. 6 is a structural diagram of a system for recommending a video from a video library according to an embodiment of the present invention.

### DESCRIPTION OF EMBODIMENTS

To make the objectives, technical solutions, and advantages of the embodiments of the present invention more comprehensible, the following clearly describes the technical solutions in the embodiments of the present invention with reference to the accompanying drawings in the embodiments of the present invention. The described embodiments are merely a part rather than all of the embodiments of the present invention. All other embodiments obtained by persons of ordinary skill in the art based on the embodiments of the present invention without creative efforts shall fall within the protection scope of the present invention.

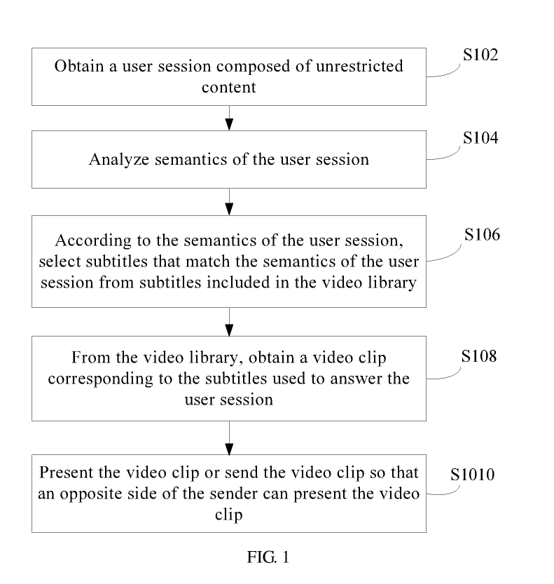

An embodiment of the present invention provides a method for recommending a video from a video library, as shown in FIG. 1. FIG. 1 is a schematic flowchart of an embodiment of the present invention. The method includes: S102: obtain a user session composed of unrestricted content; S104: analyze semantics of the user session; S106: according to the semantics of the user session, select subtitles that match the semantics of the user session from subtitles included in the video library, where the subtitles are used to answer the user session; S108: from the video library, obtain a video clip corresponding to the subtitles used to answer the user session; and S1010: present the video clip or send the video clip so that a receiver can present the video clip.

In an embodiment of the present invention, for example, a received user session is “What is the meaning of life”; the user session is analyzed to obtain the semantics “meaning of life”; based on the user session semantics “meaning of life”, subtitles “I'm Forrest Gump. Do you want chocolate? I can eat at lot. My mama always said, life is like a box of chocolate, you never know what you are going to get” for answering the user session is selected from the subtitles included in the database; subtitles and a video clip in the movie “Forrest Gump” corresponding to the subtitles used to answer the user session is obtained from the video library, and the video clip is presented.

In the embodiment of the present invention, the user session provided in the embodiment is only a specific application scenario of the present invention, and the content of the user session is unrestricted. User sessions with restricted content include a session corresponding to content included in a preset database, a user session whose session content or topic belongs to a specific or preset scope, a user session whose session sentence pattern belongs to a specific sentence pattern, and a user session under other similar restrictions. A user session composed of unrestricted content is not limited to any preset database, any sentence pattern, any language, and any topic.

The semantics of the user session are analyzed, and subtitles that match the semantics of the user session is selected from the subtitles included in the video library, and then the video clip corresponding to the subtitles is played. In this way, the video is recommended to the user automatically and smartly.

In the embodiment of the present invention, the semantics of the user session in S104 not only include literal semantics of the user session, but also include meanings implied by the user session words and real meanings of the user session. In the embodiment of the present invention, many existing algorithms are available for analyzing the semantics of a user session, and are implemented by various types of machine recognition algorithms, including but not limited to, latent semantic indexing (LSI) method, probabilistic latent semantic indexing (PLSI) method, latent Dirichlet allocation model (LDA) method, regularized latent semantic indexing (RLSI) method, non-negative matrix factorization (NMF) method, and so on.

In the embodiment of the present invention, the according to the semantics of the user session, select subtitles that match the semantics of the user session from subtitles included in the video library, where the subtitles are used to answer the user session in S106 may be implemented by the following method: using the semantics of the user session as an input, and calculating correlation separately for the subtitles included in the video library; ranking the subtitles in the video library according to a result of the correlation calculation; and selecting a subtitles ranked first or high as the subtitles used to answer the user session. Nevertheless, persons skilled in the art may implement the foregoing method in other ways. Many existing algorithms are available for implementing S106, including, but not limited to: vector space model (VSM), language models for information retrieval (LMIR), or learning to rank.

In another embodiment of the present invention, the according to the semantics of the user session, selecting subtitles that match the semantics of the user session from subtitles included in the video library, where the subtitles are used to answer the user session includes: according to the semantics of the user session and context information of the user session, selecting the subtitles that matches the semantics of the user session from the subtitles included in the video library; and the context information of the user session includes input time information of the user session, input position information of the user session, weather information in the input position at the input time, or user behavior habit information of the user session.

The selecting the subtitles that matches the semantics of the user session from the subtitles included in the video library according to the semantics of the user session and context information of the user session may also be understood as: matching the user session for a script library in the video library according to the semantics of the user session and the context information of the user session. S106 may be implemented by the following method: using the semantics of the user session and the context information of the user session as a query input, calculating correlation separately for the subtitles in the video library, ranking the subtitles in the video library according to the calculated correlation, and selecting subtitles ranked according to correlation first after correlation ranking in the video library as a subtitles used to answer the user session.

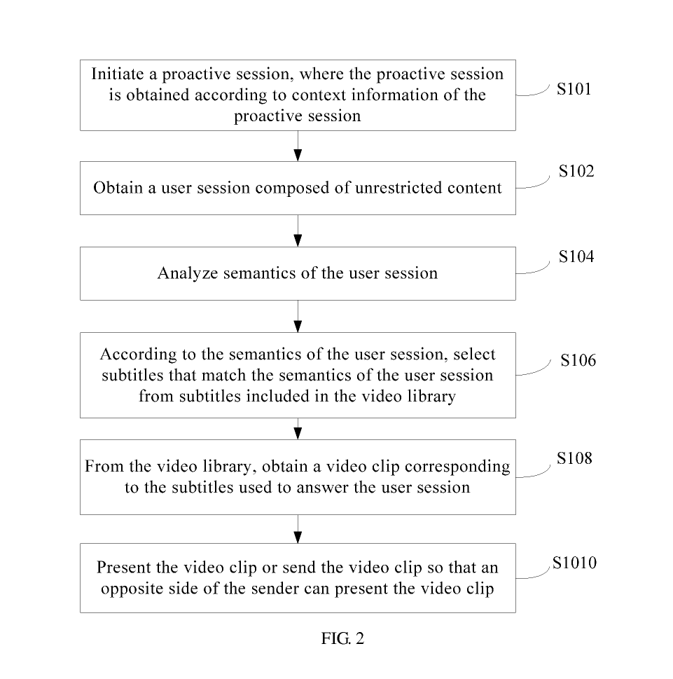

Referring to FIG. 2, FIG. 2 is a flowchart of a video recommendation method according to another embodiment of the present invention. Before the obtaining a user session composed of unrestricted content, the method further includes S101: initiating a proactive session, where the proactive session is obtained according to context information of the proactive session; and the context information of the proactive session includes initiation time information of the proactive session, object position information of the proactive session, weather information in the object position at the initiation time, and user habit history information of a proactive session object. The proactive session is used to proactively initiate a session before the user session input by the user is received, which avoids the problem that the video recommendation function is not available when the user makes no session input in a long time.

In an embodiment of the present invention, for example, a proactive session “Good night. No intention to sleep yet?” is initiated according to the initiation time information of the proactive session, and the received user session is “Just hard to get into sleep”; it is analyzed that the semantics of the user session include “hard to get into sleep”; and, based on the user session semantics “hard to get into sleep”, subtitles “Night is so long while Miss Jingjing is also hard to get into sleep” for answering the user session is selected from the subtitles included in the database; a video clip in the movie “Big Words of Western Tour” corresponding to the subtitles used to answer the user session is obtained from the video library, and the video clip is presented.

In another embodiment of the present invention, for example, according to the initiation time information of the proactive session and the weather in the position of the object, a proactive session “Hi, it seems raining outside” is initiated and the received user session is “Really? I′d like to go for a blow on a beach”; it is analyzed that the semantics of the user session include “go for a blow”; based on the user session semantics “go for a blow”, subtitles “I'd like to go for a blow with you, although at different time and space” for answering the user session is selected from the subtitles included in the database subtitles; and a video clip in the movie “Want to Go For a Blow with You” corresponding to the subtitles used to answer the user session is obtained from the video library, and the video clip is presented.

In another embodiment of the present invention, for example, according to the habit history of the proactive session user who is accustomed to browsing and selecting the latest movies, a proactive session “Hi, Prequel to Lord of the Rings was published yesterday” is initiated, and the received user session is “Really? Can I have watch it now?”; it is analyzed that the semantics of the user session include “want to watch Prequel to Lord of the Rings”; and, based on the user session semantics “want to watch Prequel to Lord of the Rings”, a video clip in the movie “Prequel to Lord of the Rings” in the video library is obtained from the video library, and the video clip is presented.

Before S102, S101 is added to initiate a proactive session, and a natural session is proactively initiated when the user does not proactively talk with the machine, which further enhances automation and smartness of the movie recommendation method provided in the embodiment of the present invention.

The context information of the proactive session is used as an input to generate a proactive session. Many existing algorithms are available for implementing S101, including but not limited to a matrix factorization algorithm or feature-based matrix factorization.

In an embodiment of the present invention, the obtaining from the video library a video clip corresponding to the subtitles used to answer the user session and presenting the video clip, or sending the video clip so that a receiver can present the video clip, includes: from the video library, obtaining multiple video clips corresponding separately to multiple subtitles used to answer the user session and presenting the multiple video clips, or sending the multiple video clips so that the receiver can present the multiple video clips; and after the obtaining from the video library multiple video clips corresponding to subtitles used to answer the user session and presenting the multiple video clips, the method further includes: obtaining a video clip selection instruction of selecting a specified video clip from the multiple video clips; and setting a video, which includes the selected specified video clip, as a video to be played. The obtaining from the video library multiple video clips corresponding separately to multiple subtitles used to answer the user session and presenting the multiple video clips, or sending the multiple video clips so that the receiver can present the multiple video clips, may be implemented in the following manner: using the semantics of the user session and the context information of the user session as a query input, calculating correlation separately for the subtitles in the video library, ranking the subtitles in the video library according to correlation according to the calculated correlation, and selecting subtitles ranked high according to correlation after correlation ranking in the video library as a subtitles used to answer the user session. The ranking high may be preset, may be set by the user, or may be obtained in another similar manner.

In the embodiment of the present invention, multiple subtitles are obtained, the video clips corresponding to the multiple subtitles provide opportunities for the user to select one from the multiple video clips. In this way, automatic recommendation is combined with the user selection to recommend the movies that more cater for user requirements.

In an embodiment of the present invention, the user session includes a voice session or includes a hybrid voice session that is composed of unrestricted content and includes a voice session and a text session.

In an embodiment of the present invention, the user session includes a text session.

In an embodiment of the present invention, the user session includes a multilingual hybrid session. For example, the user session includes two languages such as Chinese and Japanese; or, the user session includes three languages such as Chinese, English and Japanese. The user session may include, but without being limited to, the foregoing combinations, and may be a combination of any languages.

In an embodiment of the present invention, the entity for performing the method for recommending a video from a video library is a cloud server. Before the obtaining a user session composed of unrestricted content, the method further includes obtaining, by a terminal device, a user session composed of unrestricted content, and sending the user session to the cloud server. The obtaining the user session composed of unrestricted content includes receiving, by the cloud server, the user session composed of unrestricted content from the terminal device; and the sending the video clip so that a receiver can present the video clip includes sending, by the cloud server, the video clip to the terminal device so that the terminal device can present the video clip.

In the method provided in the embodiment of the present invention, the operations of receiving the user session and presenting the video clip are performed by the terminal device, and the operations of analyzing the semantics of the user session, selecting the subtitles and obtaining the video clip are performed on the cloud side. The operations of mass data storage and massive precise data processing are put on the cloud side, which helps increase the service speed and relieve the terminal load.

In an embodiment of the present invention, the initiating a proactive session in S101 includes: initiating, by the terminal device, a proactive session, where the proactive session is obtained by the terminal device according to context information of the proactive session. In an embodiment of the present invention, the initiating a proactive session in S101 includes: initiating, by the terminal device, a proactive session, where the proactive session is obtained by the cloud side according to context information of the proactive session; and, receiving, by the terminal device, the context information obtained by the cloud side.

The entities for performing the steps are not limited to those described above, and may be set flexibly according to actual applications. For example, the operation of analyzing the semantics of the user session is performed by the terminal device; the operation of presenting the video clip is jointly performed by the cloud side and the terminal device; and the operations of receiving the user session, presenting the video clip, analyzing the semantics of the user session, selecting the subtitles, and obtaining the video clip are performed by the terminal device, or in other manners that can easily come into the minds of persons skilled in the art.

In an embodiment of the present invention, the entity for performing the method for recommending a video from a video library is the terminal device. Steps S101 to S1010 above are all performed by the terminal device. The presenting the video clip or sending the video clip so that a receiver can present the video clip includes presenting, by the terminal device, the video clip.

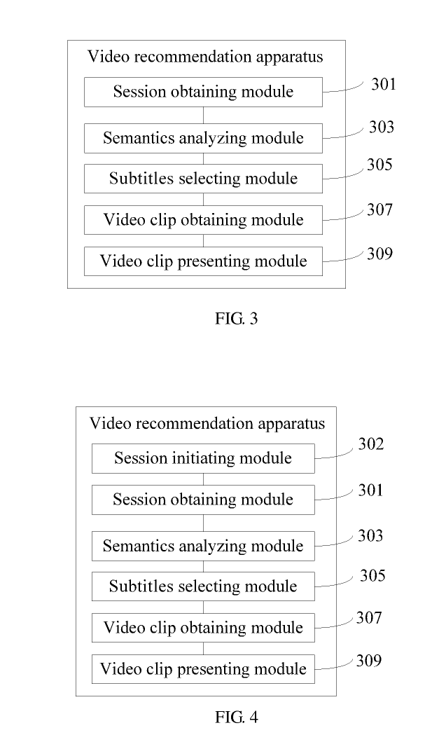

An embodiment of the present invention provides an apparatus for recommending a video from a video library, as shown in FIG. 3. FIG. 3 is a schematic structural diagram of a video recommendation apparatus according to an embodiment of the present invention. The apparatus includes a session obtaining module 301, a semantics analyzing module 303, a subtitles selecting module 305, a video clip obtaining module 307, and a video clip presenting module 309. The session obtaining module 301 is configured to obtain a user session composed of unrestricted content; the semantics analyzing module 303 is configured to analyze semantics of the user session; the subtitles selecting module 305 is configured to: according to the semantics of the user session, select subtitles that match the semantics of the user session from subtitles included in the video library, where the subtitles are used to answer the user session; the video clip obtaining module 307 is configured to obtain from the video library a video clip corresponding to the subtitles used to answer the user session; and the video clip presenting module 309 is configured to present the video clip, or send the video clip so that a receiver can present the video clip.

In an embodiment of the present invention, the subtitles selecting module 305 is configured to according to the semantics of the user session and context information of the user session, select the subtitles used to answer the user session from the subtitles included in the video library, where the context information of the user session includes input time information of the user session, input position information of the user session, weather information in the input position at the input time, or user behavior information of the user session.

In an embodiment of the present invention, as shown in FIG. 4, FIG. 4 provides a schematic structural diagram of a video recommendation apparatus according to another embodiment of the present invention. The apparatus further includes a session initiating module 302, the session initiating module 302 is configured to initiate a proactive session before a user session composed of unrestricted content is obtained, where the proactive session is obtained according to context information of the proactive session, and the context information of the proactive session includes initiation time information of the proactive session, object position information of the proactive session, weather information in the object position at the initiation time, and user habit history information of a proactive session object.

In an embodiment of the present invention, the apparatus further includes a playing module 304. The video clip obtaining module 307 is configured to obtain from the video library multiple video clips corresponding separately to multiple subtitles used to answer the user session; the video clip presenting module 307 is configured to present the multiple video clips; the session obtaining module 301 is further configured to obtain a video clip selection instruction of selecting a specified video clip from the multiple video clips; and the playing module is configured to set a video, which includes the selected specified video clip, as a video to be played.

In an embodiment of the present invention, the session obtaining module 301 is specifically configured to obtain a voice session composed of unrestricted content, or a hybrid voice session that is composed of unrestricted content and includes a voice session and a text session.

In an embodiment of the present invention, the session obtaining module 301 is specifically configured to obtain a text session composed of unrestricted content.

In an embodiment of the present invention, the obtaining the user session specifically includes obtaining, by the session obtaining module 301, a multilingual hybrid session composed of unrestricted content.

In an embodiment of the present invention, the session obtaining module 301, the semantics analyzing module 303, the subtitles selecting module 305, the video clip obtaining module 307, and the video clip presenting module 309 are all distributed on a terminal device; the session obtaining module 301 is configured to directly obtain the user session composed of unrestricted content from a user input; and the video clip presenting module 309 is configured to present the video clip.

In another embodiment of the present invention, the session obtaining module 301, the semantics analyzing module 303, the subtitles selecting module 305, the video clip obtaining module 307, and the video clip presenting module 309 are all distributed on a cloud server; the session obtaining module 301 is configured to receive the user session composed of unrestricted content from the terminal device; the user session composed of unrestricted content, which is sent by the terminal device, is obtained by the terminal device from the user input; and the video clip presenting module 309 is configured to send the video clip to the terminal device so that the terminal device can present the video clip.

An embodiment of the present invention provides a computer system for recommending a video from a video library as shown in FIG. 5, and the computer system includes a bus 51, a processor 52, a memory 53, and an input and output device 54; the processor 52, the memory 53, and the input and output device 54 are connected through the bus 51; the memory 53 is configured to store data and code; The processor 52 is coupled with the memory 53, and calls the data and code in the memory 53 to implement the following method: controlling the input and output device 54 to obtain a user session composed of unrestricted content; analyzing semantics of the user session; according to the semantics of the user session, selecting a subtitles used to answer the user session from subtitles included in the video library stored in the memory 53; and from the video library stored in the memory 53, obtaining a video clip corresponding to the subtitles used to answer the user session, and presenting the video clip.

In an embodiment of the present invention, the input and output device 54 may be a text input device such as a keyboard, a touchscreen, or a mouse; and the controlling the input and output device 54 to obtain the user session composed of unrestricted content includes controlling the text input device to receive a text user session composed of unrestricted content.

In an embodiment of the present invention, the input and output device 54 may be a microphone; and the controlling the input and output device 54 to obtain the user session composed of unrestricted content includes controlling the microphone to receive a text user session composed of unrestricted content.

In an embodiment of the present invention, the processor 52 coupled with the memory 53 is further configured to call programs or data in the memory 53 to implement the following functions: according to the semantics of the user session and context information of the user session, selecting the subtitles used to answer the user session from the subtitles included in the video library, where the context information of the user session includes: input time information of the user session, input position information of the user session, weather information in the input position at the input time, or user behavior information of the user session.

In an embodiment of the present invention, the processor 52 coupled with the memory 53 is further configured to call programs or data in the memory 53 to implement the following functions: before the user session composed of unrestricted contents is obtained, initiating a proactive session, where the proactive session is obtained according to context information of the proactive session; and the context information of the proactive session includes: initiation time information of the proactive session, object position information of the proactive session, weather information in the object position at the initiation time, and user habit history information of a proactive session object.

In an embodiment of the present invention, the processor 52 coupled with the memory 53 is further configured to call programs or data in the memory 53 to implement the following functions: from the video library, obtaining multiple video clips corresponding separately to multiple subtitles used to answer the user session and presenting the multiple video clips, or sending the multiple video clips so that the receiver can present the multiple video clips; and after the obtaining from the video library multiple video clips corresponding to subtitles used to answer the user session and presenting the multiple video clips, the method further includes: obtaining a video clip selection instruction of selecting a specified video clip from the multiple video clips; and setting a video, which includes the selected specified video clip, as a video to be played.

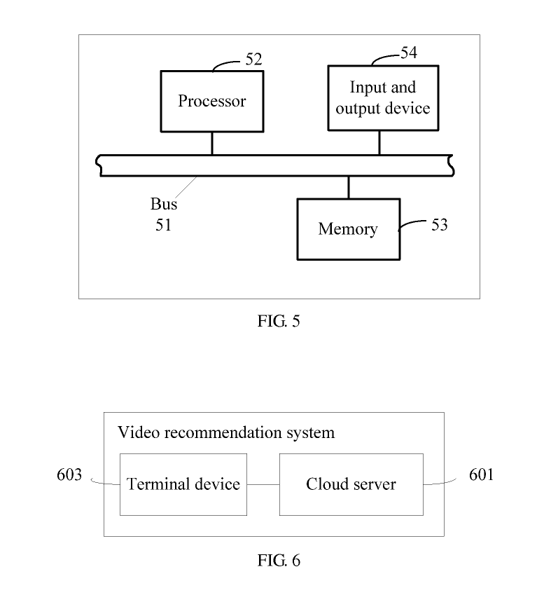

An embodiment of the present invention provides a system for recommending a video from a video library. FIG. 6 provides a structural diagram of the embodiment of the present invention. The system includes a cloud server 601 and a terminal device 603. The terminal device 603 is configured to receive a user session that is composed of unrestricted content and input by a user, and send the user session to the cloud server 601; the cloud server 601 is configured to: receive a user session composed of unrestricted content; analyze semantics of the user session; according to the semantics of the user session, select subtitles that match the semantics of the user session from subtitles included in the video library, where the subtitles are used to answer the user session; from the video library, obtain a video clip corresponding to the subtitles used to answer the user session; and send the video clip to the terminal device 603; and the terminal device 603 is further configured to present the video clip.

In an embodiment of the present invention, the cloud server 601 is further configured to initiate a proactive session, and send the proactive session to the terminal device 603, where the proactive session is obtained according to context information of the proactive session; the context information of the proactive session includes: initiation time information of the proactive session, object position information of the proactive session, weather information in the object position at the initiation time, and user habit history information of a proactive session object; and the terminal device 603 is further configured to before receiving the user session composed of unrestricted content that is input by the user, receive the proactive session, and present the proactive session to the user, where the received user session composed of unrestricted content is triggered by the proactive session.

In an embodiment of the present invention, the cloud server 601 is further configured to obtain from the video library multiple video clips corresponding separately to multiple subtitles used to answer the user session, obtain a video clip selection instruction of selecting a specified video clip from the multiple video clips, set a video, which includes the selected specified video clip, as a video to be played, and send the video to be played to the terminal device 603; and the terminal device 603 is further configured to receive the video to be played and play the video to be played.

Understandably, both the cloud server 601 and the terminal device 603 in the system in the present invention may be implemented by using a structure of a computer system shown in FIG. 5.

It is understandable to those skilled in the art that an accompanying drawing herein is only a schematic diagram of a preferred embodiment, and the modules or processes in the drawing are not necessarily required for implementing the present invention.

Those skilled in the art understand that modules in an apparatus in an embodiment of the present invention may be distributed in the apparatus of the embodiment as described herein, or otherwise located in one or more apparatuses, which is different from distribution in the embodiment. The modules in the foregoing embodiments may combine into one module, or split into multiple submodules.

Persons of ordinary skill in the art may understand that all or a part of the steps of the foregoing method embodiments may be implemented by a program instructing relevant hardware. The program may be stored in a computer readable storage medium, and the storage medium may include a read only memory (ROM)/random access memory (RAM), a magnetic disk, and an optical disc.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments, or make equivalent replacements to some technical features thereof, without departing from the spirit and scope of the technical solutions of the embodiments of the present invention.

What is claimed is:

1. A method for recommending a video from a video library, comprising:
obtaining a user session composed of unrestricted content;
analyzing semantics of the user session;
selecting, according to the semantics of the user session, subtitles that match the semantics of the user session from subtitles included in the video library, wherein the subtitles are used to answer the user session;
obtaining, from the video library, a video clip corresponding to the subtitles used to answer the user session; and
either presenting the video clip or sending the video clip so that a receiver can present the video clip.

2. The method according to claim 1, wherein selecting subtitles that match the semantics of the user session comprises selecting, according to the semantics of the user session and context information of the user session, the subtitles that match the semantics of the user session from the subtitles included in the video library, and wherein the context information of the user session comprises input time information of the user session, input position information of the user session, weather information in the input position at the input time, or user behavior habit information of the user session.

3. The method according to claim 1, wherein selecting subtitles that match the semantics of the user session comprises:
using the semantics of the user session as an input;
calculating correlation separately for the subtitles in the video library;
ranking the subtitles in the video library according to a result of the correlation calculation; and
selecting a subtitles ranked first or high as the subtitles that matches the semantics of the user session.

4. The method according to claim 1, wherein before obtaining the user session composed of unrestricted content, the method further comprises initiating a proactive session, wherein the proactive session is obtained according to context information of the proactive session, and wherein the context information of the proactive session comprises initiation time information of the proactive session, object position information of the proactive session, weather information in the object position at the initiation time, and user habit history information of a proactive session object.

5. The method according to claim 1, wherein obtaining from the video library the video clip and presenting the video clip or sending the video clip so that a receiver can present the video clip comprises:
obtaining from the video library multiple video clips corresponding separately to multiple subtitles used to answer the user session; and
presenting the multiple video clips, or sending the multiple video clips so that the receiver can present the multiple video clips, and
wherein after obtaining from the video library multiple video clips and presenting the multiple video clips or sending the multiple video clips so that the receiver can present the multiple video clips, the method further comprises:
obtaining a video clip selection instruction of selecting a specified video clip from the presented multiple video clips; and
setting a video that comprises the selected specified video clip as a video to be played.

6. The method according to claim 1, wherein the user session comprises a voice session or comprises a hybrid session that comprises the voice session and a text session, and wherein obtaining the user session composed of unrestricted content comprises receiving the voice session composed of unrestricted content or the hybrid session that comprises the voice session and the text session.

7. The method according to claim 1, wherein the user session comprises a text session, and wherein obtaining the user session composed of unrestricted content comprises obtaining the text session composed of unrestricted content.

8. The method according to claim 1, wherein the user session comprises a multilingual hybrid session, and wherein obtaining the user session composed of unrestricted content comprises obtaining the multilingual hybrid session composed of unrestricted content.

9. An apparatus for recommending a video from a video library, comprising:
a session obtaining module configured to obtain a user session composed of unrestricted content;
a semantics analyzing module configured to analyze semantics of the user session;
a subtitles selecting module is configured to select, according to the semantics of the user session, subtitles that match the semantics of the user session from subtitles included in the video library, wherein the subtitles are used to answer the user session;
a video clip obtaining module configured to obtain from the video library a video clip corresponding to the subtitles used to answer the user session; and
a video clip presenting module configured to either present the video clip or send the video clip so that a receiver can present the video clip.

10. The apparatus according to claim 9, wherein the subtitles selecting module is configured to select, according to the semantics of the user session and context information of the user session, the subtitles used to answer the user session from the subtitles included in the video library, and wherein the context information of the user session comprises input time information of the user session, input position information of the user session, weather information in the input position at the input time, or user behavior information of the user session.

11. The apparatus according to claim 9, wherein selecting subtitles that match the semantics of the user session comprises:
using the semantics of the user session as an input;
calculating correlation separately for the subtitles in the video library;
ranking the subtitles in the video library according to a result of the correlation calculation; and
selecting a subtitles ranked first or high as the subtitles that matches the semantics of the user session.

12. The apparatus according to claim 9, further comprising a session initiating module, wherein the session initiating module is configured to initiate a proactive session before the user session composed of unrestricted content is obtained, wherein the proactive session is obtained according to context information of the proactive session, and wherein the context information of the proactive session comprises initiation time information of the proactive session, object position information of the proactive session, weather information in the object position at the initiation time, and user habit history information of a proactive session object.

13. The apparatus according to claim 9, further comprising a playing module, wherein the video clip obtaining module is configured to obtain from the video library multiple video clips corresponding separately to multiple subtitles used to answer the user session, wherein the video clip presenting module is configured to present the multiple video clips or is configured to send the multiple video clips so that a receiver can present the multiple video clips, wherein the session obtaining module is further configured to obtain a video clip selection instruction of selecting a specified video clip from the presented multiple video clips, and wherein the playing module is configured to set a video that comprises the selected specified video clip as the video to be played.

14. The apparatus according to claim 9, wherein the session obtaining module is configured to obtain either the voice session composed of unrestricted content or a hybrid voice session that is composed of unrestricted content and includes a voice session and a text session.

15. The apparatus according to claim 9, wherein the session obtaining module is configured to obtain a text session composed of unrestricted content.

16. The apparatus according to claim 9, wherein the session obtaining module is configured to obtain a multilingual hybrid session composed of unrestricted content.

17. A system for recommending a video from a video library, comprising:
a cloud server; and
a terminal device configured to:
receive a user session that is input by a user and composed of unrestricted content; and
send the user session to the cloud server;
wherein the cloud server is configured to:
receive the user session composed of unrestricted content;
analyze semantics of the user session;
select, according to the semantics of the user session, subtitles that match the semantics of the user session from subtitles included in the video library, wherein the subtitles are used to answer the user session;
obtain, from the video library, a video clip corresponding to the subtitles used to answer the user session; and
send the video clip to the terminal device; and the terminal device is further configured to present the video clip.

18. The system according to claim 17, wherein the cloud server is further configured to:
initiate a proactive session; and
send the proactive session to the terminal device, wherein the proactive session is obtained according to context information of the proactive session,
wherein the context information of the proactive session comprises initiation time information of the proactive session, object position information of the proactive session, weather information in the object position at the initiation time, and user habit history information of a proactive session object, and
wherein the terminal device is further configured to:
receive the proactive session before receiving the user session composed of unrestricted content that is input by the user; and
present the proactive session to the user, wherein the received user session composed of unrestricted content is triggered by the proactive session.

19. The system according to claim 17, wherein the cloud server is further configured to:
obtain from the video library multiple video clips corresponding separately to multiple subtitles used to answer the user session;
obtain a video clip selection instruction of selecting a specified video clip from the multiple video clips;
set a video that comprises the selected specified video clip as the video to be played; and
send to the terminal device the video to be played, and
wherein the terminal device is further configured to:
receive the video to be played; and
play the video to be played.
